(19) United States
(12) Patent Application Publication
(10) Pub. No.: US 2020/0070738 A1
(43) Pub. Date: Mar. 5, 2020

(54) VEHICLE IMAGING UNIT ARRANGEMENT STRUCTURE

(71) Applicant: HONDA MOTOR CO., LTD., Tokyo (JP)

(72) Inventors: Makoto Sawada, Wako-shi (JP); Eiji Ishizuka, Wako-shi (JP)

(21) Appl. No.: 16/535,145

(22) Filed: Aug. 8, 2019

(30) Foreign Application Priority Data
Aug. 28, 2018 (JP) 2018-159707

(51) Int. Cl. B60R 11/04; B60R 1/00; E05B 85/10; H04N 5/225; H04N 7/18

(52) U.S. Cl. CPC B60R 11/04; B60R 1/00; E05B 85/107; B60R 2011/004; H04N 5/2253; H04N 7/188; E05B 85/103

(57) ABSTRACT

In a vehicle imaging unit arrangement structure, a vehicle imaging unit includes an imaging device which captures an image of surroundings of the vehicle and which outputs the captured image to a display device. The vehicle imaging unit is arranged in a height range from a height of 925 mm from a ground surface to a maximum vehicle height.

### CROSS-REFERENCE TO RELATED APPLICATION

Priority is claimed on Japanese Patent Application No. 2018-159707, filed on Aug. 28, 2018, the contents of which are incorporated herein by reference.

### BACKGROUND

### Field of the Invention

The present invention relates to an arrangement structure of a vehicle imaging unit that includes an imaging device which images the surroundings of a vehicle.

### Background

A technique is known in which an imaging unit (a camera) having an imaging device that images a side rear direction of a vehicle and a monitor that displays an image captured by the imaging device are integrated, and the integrated monitor unit is attached to a triangular window portion at a front part of a front side door (refer to Published Japanese Translation No. 2013-520363 of the PCT International Publication).

In the monitor unit described in Published Japanese Translation No. 2013-520363 of the PCT International Publication, in a state where the monitor unit is attached to the triangular window portion of the front side door, the monitor is arranged in a vehicle room, and the imaging unit is arranged outside the vehicle room. An imaging lens of the imaging unit is arranged on a rear surface of a housing such that an optical axis of the imaging lens is directed to the side rear direction of the vehicle.

### SUMMARY

However, a height position of the imaging unit arranged outside the vehicle is not sufficiently considered with respect to the monitor unit described in Published Japanese Translation No. 2013-520363 of the PCT International Publication.

In a case where the surroundings of a vehicle is imaged using an imaging unit, when traveling at night, there may be cases in which recognition of the silhouette of a following vehicle is prevented by halation due to the light of the headlight of the following vehicle. Currently, it is desired to resolve this problem by appropriate arrangement of the imaging unit.

An aspect of the present invention provides a vehicle imaging unit arrangement structure capable of preventing occurrence of halation at a display part due to light of a headlight of another vehicle.

A vehicle imaging unit arrangement structure according to an aspect of the present invention is an arrangement structure of a vehicle imaging unit that is arranged on an outside part of a vehicle and that includes an imaging device which captures an image of a surrounding of the vehicle and which outputs the captured image to a display device, wherein the vehicle imaging unit is arranged in a height range from a height of 925 mm from a ground surface to a maximum vehicle height.

According to researches by the inventors of the present invention, the height position at which a headlight of a vehicle used on a public road is arranged is about 950 mm from the ground at the highest, and in consideration of the optical axis of the headlight being directed slightly downward, it is found that, when an imaging device is at a height of 925 mm or more from the ground, halation due to the light of a headlight of a following vehicle does not easily occur.

In the present arrangement structure, since the vehicle imaging unit is arranged in a height range from a height of 925 mm from the ground surface to a maximum vehicle height, it is possible to prevent occurrence of halation at the display part due to the light of a headlight of another vehicle. Accordingly, when the present arrangement structure is employed, it becomes possible to clearly recognize the silhouette of a following vehicle using the display device when traveling at night.

The vehicle imaging unit may be arranged at a lower position than a door waist part of a side door.

In this case, it becomes difficult for the vehicle imaging unit to enter the driver's view through a window frame part above the door waist part. Therefore, when this structure is employed, it is possible to further widely ensure the driver's direct view.

The vehicle imaging unit may be arranged at a higher position than a character line that is provided to protrude on an outer surface of a vehicle body side part and that extends substantially in a vehicle front-to-rear direction.

In this case, since the vehicle imaging unit is arranged at a position above the protruding character line of the vehicle body side part, the splash that is splashed by a front wheel of the vehicle when the vehicle is traveling is blocked by a raised part of the character line and hardly adheres to the vehicle imaging unit. Therefore, it is possible to make the image captured by the imaging device of the vehicle imaging unit further clear.

The vehicle imaging unit may be arranged at a side door that includes a retractable flash door handle on an outer surface of the side door, and the vehicle imaging unit and the flash door handle may be formed in the substantially same size and arranged at point-symmetrical positions with respect to a centering point on the character line in a vehicle side view.

In this case, since the vehicle imaging unit and the flash door handle are arranged in a point-symmetric manner so as to interpose the character line in a side view of the side door, the appearance design property of the side door is enhanced.

The vehicle imaging unit may be arranged at a height position at which a ratio of an amount of reflection of the vehicle to an entire display screen of the display device is equal to or less than a predetermined value.

In this case, it is possible to sufficiently ensure an amount of reflection of surroundings of the vehicle in the display screen of the display device.

According to an aspect of the present invention, the vehicle imaging unit is arranged in a height range from a height of 925 mm from the ground surface to a maximum vehicle height, and therefore, it is possible to prevent occurrence of halation at the display part due to the light of a headlight of another vehicle.

### BRIEF DESCRIPTION OF THE DRAWINGS

FIG. 1 is a perspective view showing a vehicle interior of a vehicle according to an embodiment of the present invention.

FIG. 2 is a side view of the vehicle according to the embodiment of the present invention.

FIG. 3 is a top view of the vehicle according to the embodiment of the present invention.

FIG. 4 is a front view of the vehicle according to the embodiment of the present invention.

FIG. 5 is a rear view of the vehicle according to the embodiment of the present invention.

FIG. 6 is a view showing a display of a monitor of a rear display system according to the embodiment of the present invention.

FIG. 7 is a top view of an imaging unit according to the embodiment of the present invention.

FIG. 8 is a bottom view of the imaging unit according to the embodiment of the present invention.

FIG. 9 is a front view of the imaging unit according to the embodiment of the present invention.

FIG. 10 is a side view of the imaging unit according to the embodiment of the present invention.

FIG. 11 is a rear view of the imaging unit according to the embodiment of the present invention.

FIG. 12 is a perspective view of the imaging unit according to the embodiment of the present invention.

FIG. 13 is a cross-sectional view of the imaging unit along a XIII-XIII line of FIG. 11 according to the embodiment of the present invention.

FIG. 14 is a cross-sectional view of the imaging unit along a XIV-XIV line of FIG. 11 according to the embodiment of the present invention.

### DESCRIPTION OF EMBODIMENTS

Hereinafter, an embodiment of the present invention will be described with reference to the drawings. In the following description, frontward and rearward, upward and downward, and right and left mean frontward and rearward, upward and downward, and right and left with respect to a vehicle unless otherwise indicated. An arrow UP that indicates an upward direction of the vehicle, an arrow FR that indicates a frontward direction of the vehicle, and an arrow LH that indicates a left side direction of the vehicle are shown at appropriate positions in the drawings.

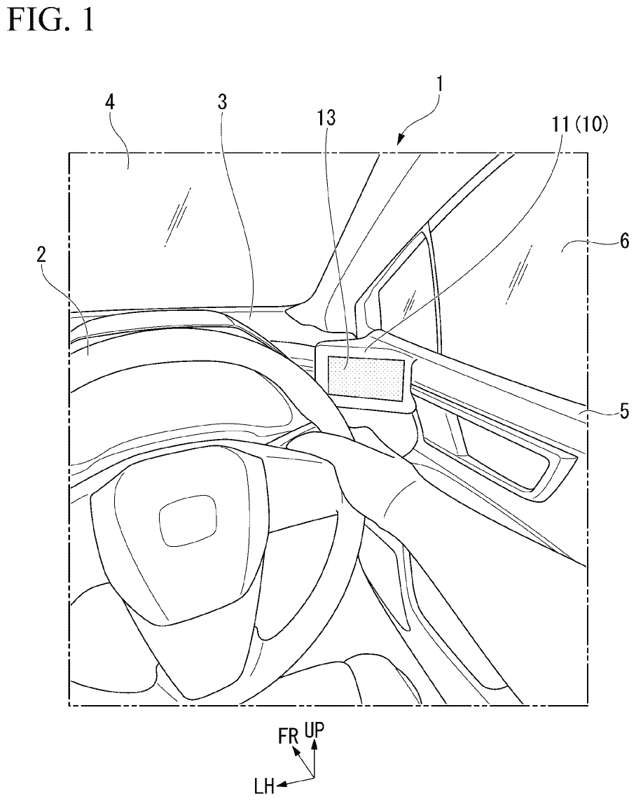

FIG. 1 is a view showing a vehicle interior of a vehicle 1 according to an embodiment. FIG. 1 is a view of a front part of a front seat (a driver seat and a passenger seat) of the vehicle when seen obliquely from a rearward upward direction.

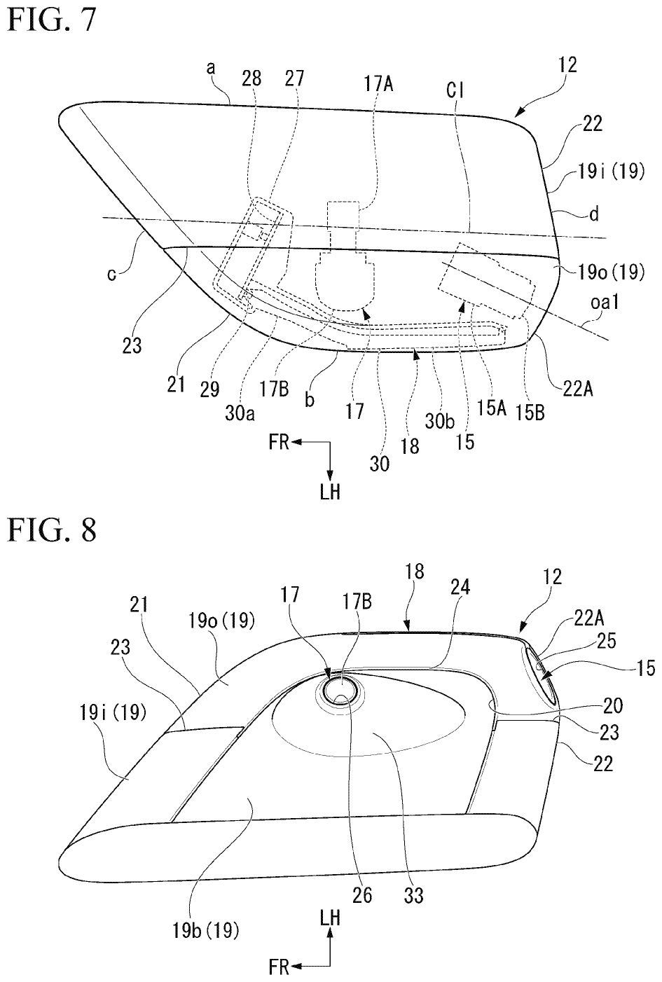

In FIG. 1, a steering wheel 2 that is arranged at a frontward position of the driver seat (not shown), an instrument panel 3, a windshield glass 4 at a frontward position in a vehicle room, and a front side door (a side door) 5 on the driver seat side are shown. A door glass 6 is provided on the front side door 5 to be movable upward and downward. The vehicle 1 according to the present embodiment is equipped with a rear display system 10 that displays the side rear direction of the vehicle in the vehicle room. The rear display system 10 captures an image of right and left rear directions of the vehicle using a rearward direction imaging device 15 (an imaging device, refer to FIG. 7 and the like) and displays the captured image on a monitor 11 (a display device) in the vehicle room.

The rear display system 10 includes a rearward direction imaging device 15 that is arranged on an outer side of each of right and left front side doors 5, a pair of monitors 11 each of which is provided in the vehicle room and corresponds to each of the right and left rear imaging devices 15, and a control device (not shown) that controls the rearward direction imaging device 15 and the monitor 11. The monitor 11 corresponding to each of the right and left rear imaging devices 15 is arranged in the vicinity of a lower end of right and left front pillars 7 in the vehicle interior. An image of the left rear direction of the vehicle is displayed on the monitor 11 at the lower end of the left front pillar 7. An image of the right rear direction of the vehicle is displayed on the monitor 11 at the lower end of the right front pillar 7.

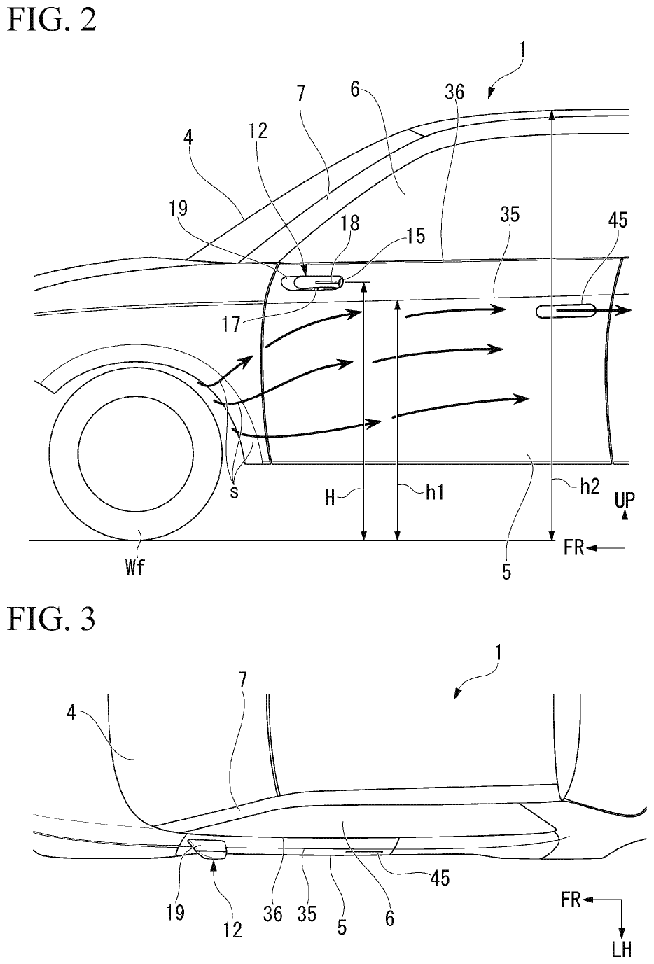

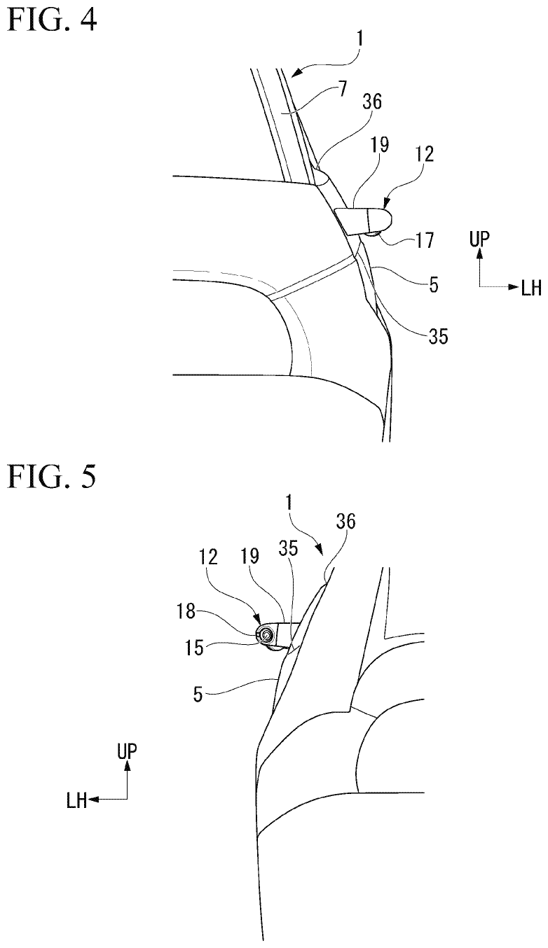

FIG. 2 is a view seen from the left side direction of the vehicle 1. FIG. 3 is a view seen from the upward direction of a left half region of the vehicle 1. FIG. 4 is a view seen from the frontward direction of the left half region of the vehicle 1. FIG. 5 is a view seen from the rearward direction of the left half region of the vehicle.

As shown in FIGS. 2 to 5, a vehicle imaging unit 12 (hereinafter, referred to as an “imaging unit 12”) that incorporates the rearward direction imaging device 15 described above is attached to an outer side surface of the left front side door 5. An imaging unit 12 similar to the left one is also attached to an outer side surface of the right front side door 5.

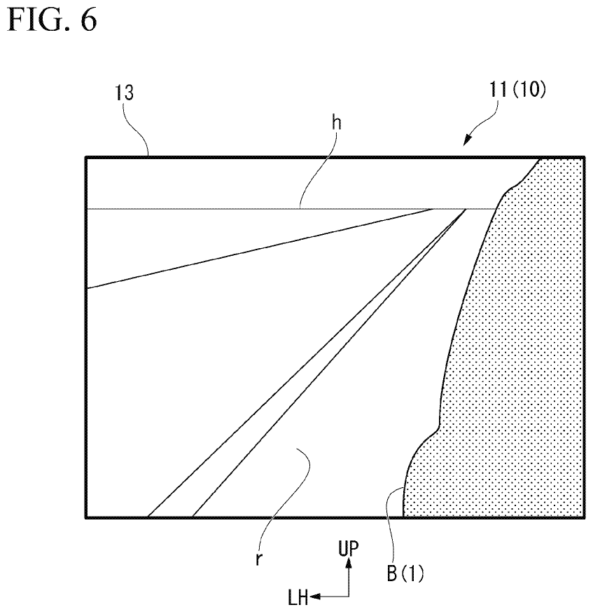

FIG. 6 is a view showing a display screen 13 of the monitor 11 that is provided in the vehicle room.

An image of the side rear direction that is captured by the rearward direction imaging device 15 is displayed on the display screen 13 of the monitor 11 together with part of a vehicle body B at the side part of the vehicle. The display screen 13 is set such that when the vehicle 1 travels on a flat road surface, a horizontal line h in the vehicle rear direction and a road surface r in the vehicle rear direction by a predetermined distance are simultaneously displayed on the display screen 13. An imaging target to be reflected on the display screen 13 is appropriately set in accordance with a size of the display screen 13, an arrangement height and a position in the front-to-rear direction of the rearward direction imaging device 15, a field angle, or the like. An amount of reflection of the vehicle on the display screen 13 is set to, for example, 10% or less of the entire display screen 13.

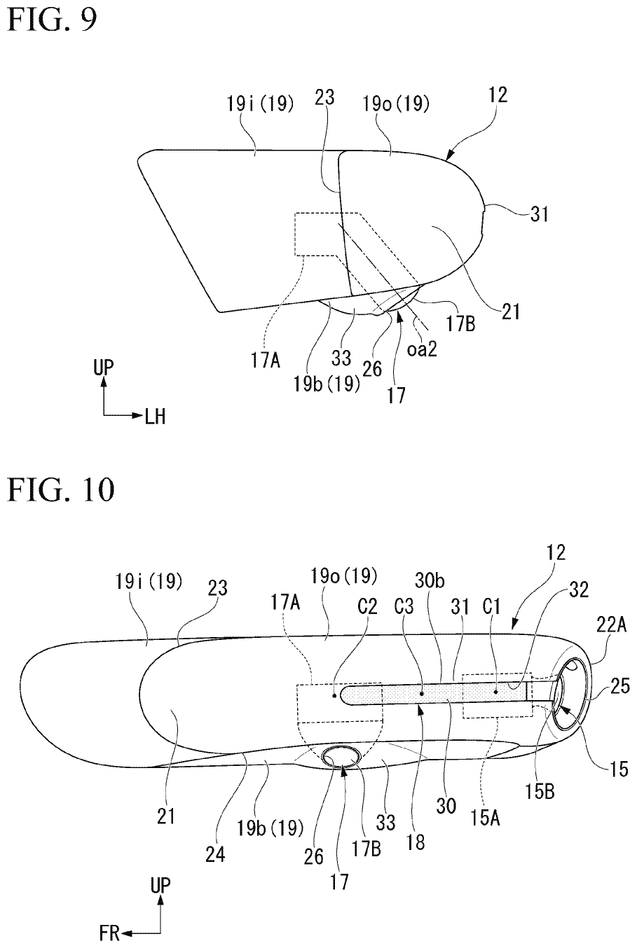

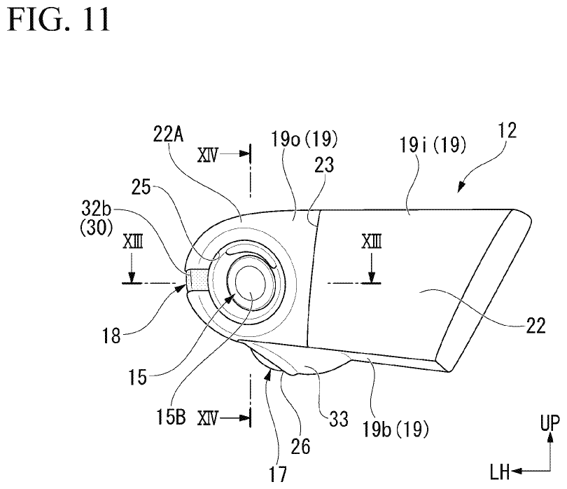

FIG. 7 is a top view of the imaging unit 12 that is provided on the left front side door 5. FIG. 8 is a bottom view of the imaging unit 12. FIG. 9 is a front view of the imaging unit 12. FIG. 10 is a side view of the imaging unit 12. FIG. 11 is a rear view of the imaging unit 12.

As shown in FIGS. 7 to 11, the imaging unit 12 includes the rearward direction imaging device 15 that images a side rear direction of the vehicle, a downward direction imaging device 17 that images a side lower direction of the vehicle, a lamp unit 18 that constitutes a turn lamp, a width indicator, and the like, and a housing 19 that accommodates the rearward direction imaging device 15, the downward direction imaging device 17, and the lamp unit 18. The housing 19 is attached to an outer surface of the front side door 5 at a front part of the front side door 5 via a base member (not shown).

The housing 19 includes an inner housing 19i that is attached to the outer surface (the side part of the vehicle body) of the front side door 5, an outer housing 190 that is assembled on an outer side of the inner housing 19i in the vehicle width direction, and a bottom housing 19b that is assembled on an opening 20 at bottom portions of the inner housing 19i and the outer housing 19o. The inner housing 19i, the outer housing 19o, and the bottom housing 19b are detachably assembled together by screw fastening, clip fastening, male and female fitting, or the like. The inner housing 19i, the outer housing 19o, and the bottom housing 19b are formed of, for example, a hard plastic material.

As shown in FIG. 7, the housing 19 is formed in a substantially trapezoidal shape in a top view, in which a width of an outer side b on the outer side in the vehicle width direction is narrower than that of an inner side a on the inner side in the vehicle width direction attached to the front side door 5. A front end portion of the inner side a and a front end portion of the outer side b are connected by an inclined side c. The inclined side c is inclined outward in the vehicle width direction from the front end portion of the inner side a toward the rear side. The inclined side c and the outer side b are connected by a smooth curve. In the outer surface of the housing 19, the inclined side c and a portion corresponding to the curved portion that connects the inclined side c and the outer side b are referred to as an inclined region 21 of the housing 19. In the outer surface of the housing 19, a portion corresponding to a side d that connects rear end portions of the inner side a and the outer side b together is referred to as a rear end region 22 of the housing 19.

As shown in FIG. 7, a segmentation boundary portion 23 between the inner housing 19i and the outer housing 190 is arranged on an upper surface side of the housing 19. The segmentation boundary portion 23 on the upper surface side of the housing 19 extends straight substantially in the vehicle front-to-rear direction. The segmentation boundary portion 23 on the upper surface side of the housing 19 is arranged at a position deviated outward in the vehicle width direction from a middle (a center line c1 in FIG. 7) of the housing in the vehicle width direction. In the outer surface of the housing 19, the inner and outer sides in the vehicle width direction that interpose the segmentation boundary portion 23 are set to different colors from each other. The outer surface of the inner housing 19i and the outer surface of the outer housing 190 are constituted of a smoothly continuous surface with the segmentation boundary portion 23 interposed therebetween.

The segmentation boundary portion 23 between the inner housing 19i and the outer housing 190 extends toward a lower surface side across the front and rear end portions of the inner housing 19i and the outer housing 19o. As shown in FIG. 8, the opening 20 described above is formed on the lower surface of the outer housing 190 such that the opening 20 enters the outside of the segmentation boundary portion 23 in the vehicle width direction. A portion of the opening 20 of the outer housing 190 that enters the outside in the vehicle width direction is a segmentation boundary portion 24 between the bottom housing 19b and the outer housing 19o. The bottom housing 19b is detachably assembled to and across both lower walls of the inner housing 19i and the outer housing 19o.

The rearward direction imaging device 15 includes a device main body 15A in which an image sensor and a variety of processing circuits are built and an imaging lens 15B that captures an image of an imaging target. The rearward direction imaging device 15 is arranged at an outer portion in the vehicle width direction of a rear part in the housing 19. The imaging lens 15B is exposed to the outside of the vehicle body at an outer portion in the vehicle width direction of the rear end region 22 of the housing 19. A rearward inclined surface 22A that is directed to the side rearward direction of the vehicle is provided on an outer portion in the vehicle width direction of the rear end region 22 of the housing 19 (outer housing 19o). A first lens exposure hole 25 (a lens arrangement part) for exposing the imaging lens 15B to the outside is provided on the rearward inclined surface 22A. As shown in FIG. 7, an optical axis oa1 of the imaging lens 15B faces the vehicle rearward direction in a state of being slightly inclined outward in the vehicle width direction.

The downward direction imaging device 17 is used for a blind monitor system or the like that displays the side lower direction of the vehicle, which becomes a blind spot from the driver seat, on a monitor (not shown) on the driver seat side. The downward direction imaging device 17 includes a device main body 17A in which an image sensor and a variety of processing circuits are built and an imaging lens 17B that captures an image of an imaging target. The imaging lens 17B is exposed to the outside of the vehicle body at a lower surface in a middle region of the housing 19 in the vehicle front-to-rear direction. A second lens exposure hole 26 for exposing the imaging lens 17B to the outside is provided on a lower surface of the bottom housing 19b. As shown in FIG. 9, an optical axis oa2 of the imaging lens 17B faces the vehicle downward direction in a state of being slightly inclined outward in the vehicle width direction. As shown in FIG. 7, the rearward direction imaging device 15 is arranged at a further rearward position of the vehicle than the downward direction imaging device 17 when the housing 19 is seen from the above and is arranged inside the housing 19 such that an outer end of the imaging lens 15B in the vehicle width direction is positioned outside the downward direction imaging device 17 in the vehicle width direction. As shown in FIG. 10, the rearward direction imaging device 15 and the downward direction imaging device 17 are arranged in the housing 19 such that a position of a center c1 of the device main body 15A of the rearward direction imaging device 15 and a position of a center c2 of the device main body 17A of the downward direction imaging device 17 are substantially horizontal in a state where the housing 19 is attached to a side part of the front side door 5.

As shown in FIG. 7, the lamp unit 18 includes a base block 27 that is attached inside the housing 19, a circuit board 28 that is held by the base block 27, a lamb body 29 such as an LED that is mounted on the circuit board 28, and an elongated light guide body 30 that is held by the base block 27 and that guides the light of the lamb body 29 to a predetermined region of the outer surface of the housing 19. The light guide body 30 includes an inclined part 30a that extends obliquely outward in the vehicle width direction from the base block 27 toward the vehicle body rearward direction and a light irradiation part 30b that extends linearly from a rear end portion of the inclined part 30a to the vehicle rearward direction.

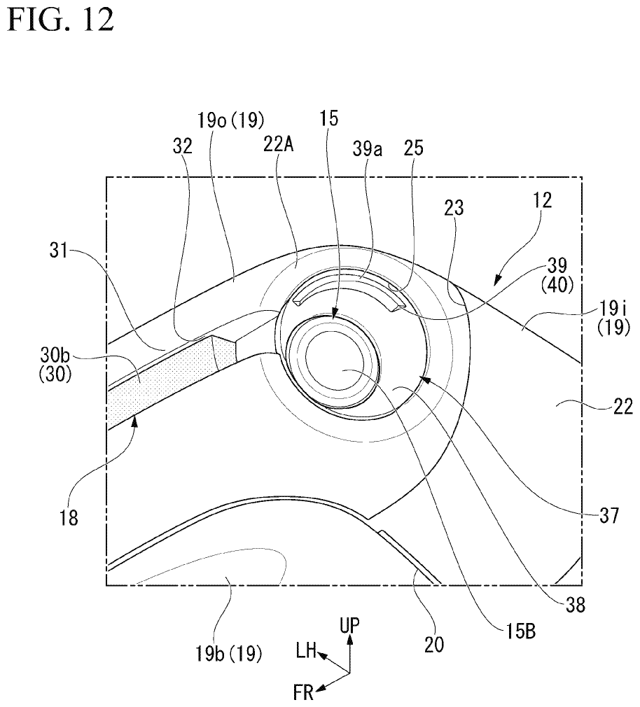

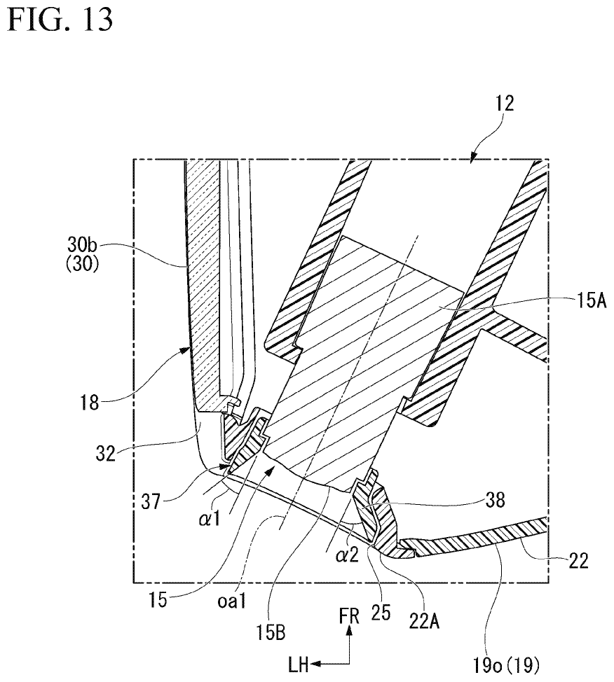

FIG. 12 is a view of the rear end region 22 of the imaging unit 12 when seen from a lower direction on the outside in the vehicle width direction. FIG. 13 is view showing a cross-section along a XIII-XIII line of FIG. 11.

A side surface of the housing 19 on the outer side in the vehicle width direction is formed of an arc surface that is curved in the vertical direction. On the side surface on the outer side in the vehicle width direction, a groove 32 (a notched part) having a substantially rectangular cross-section is formed substantially in the vehicle body front-to-rear direction at a position slightly lower than a maximum protruding part 31 that protrudes outward in the vehicle width direction. The light irradiation part 30b of the light guide body 30 of the lamp unit 18 is arranged on the groove 32 of the housing 19. A rear end portion of the light irradiation part 30b of the light guide body 30 is arranged in front of a position facing the rearward inclined surface 22A in the groove 32 of the housing 19. That is, the light irradiation part 30b is not arranged in the vicinity of the rear end portion of the groove 32 of the housing 19. Thereby, it is possible to prevent the light that is emitted from the light irradiation part 30b from being incident on the imaging lens 15B of the rearward direction imaging device 15 in advance.

The rear end portion of the groove 32 of the housing 19 may be closed by a member having no light transparency.

On the other hand, the inclined part 30a of the light guide body 30 of the lamp unit 18, the base block 27, the circuit board 28, the lamb body 29 and the like are arranged inside the housing 19. The inclined part 30a of the light guide body 30 is arranged substantially along the inclined region 21 of the outer surface of the housing 19. In the housing 19, the downward direction imaging device 17 is arranged at an inner part in the vehicle width direction of the inclined part 30a of the light guide body 30. The imaging lens 17B of the downward direction imaging device 17 is inclined obliquely downward from the device main body 17A toward the outer side in the vehicle width direction. Part of the imaging lens 17B that is inclined obliquely downward is arranged at an inner part in the vehicle width direction of the inclined part 30a of the light guide body 30. As shown in FIG. 10, the lamp unit 18 is arranged in the housing 19 such that a center c3 in the vertical direction of the lamp unit 18 is substantially horizontal to the position of the center c1 of the device main body 15A of the rearward direction imaging device 15 and the position of the center c2 of the device main body 17A of the downward direction imaging device 17 in a state where the housing 19 is attached to the side part of the front side door 5.

A protrusion part 33 that protrudes downward is provided in an outer region in the vehicle width direction of the bottom housing 19b. The protrusion part 33 is formed in a spindle shape elongated in the vehicle front-to-rear direction. The second lens exposure hole 26 for exposing the imaging lens 17B of the downward direction imaging device 17 to the lower direction of the bottom housing 19b is formed on the protrusion part 33. In the protrusion part 33, the second lens exposure hole 26 is arranged in a region wider than a width in the vehicle width direction of the second lens exposure hole 26, for example, in a region twice or more wider than the width in the vehicle width direction of the second lens exposure hole 26. The protrusion part 33 has a region that extends toward a further rearward direction of the vehicle than the second lens exposure hole 26 (imaging lens 17B).

The imaging lens 17B of the downward direction imaging device 17 is arranged such that an outer surface of the imaging lens 17B is continuous with a surface shape of the protrusion part 33 of the bottom housing 19b. The rear end portion of the protrusion part 33 that converges in a spindle shape is arranged at a position that overlaps part of the imaging lens 15B of the rearward direction imaging device 15 in the vehicle width direction.

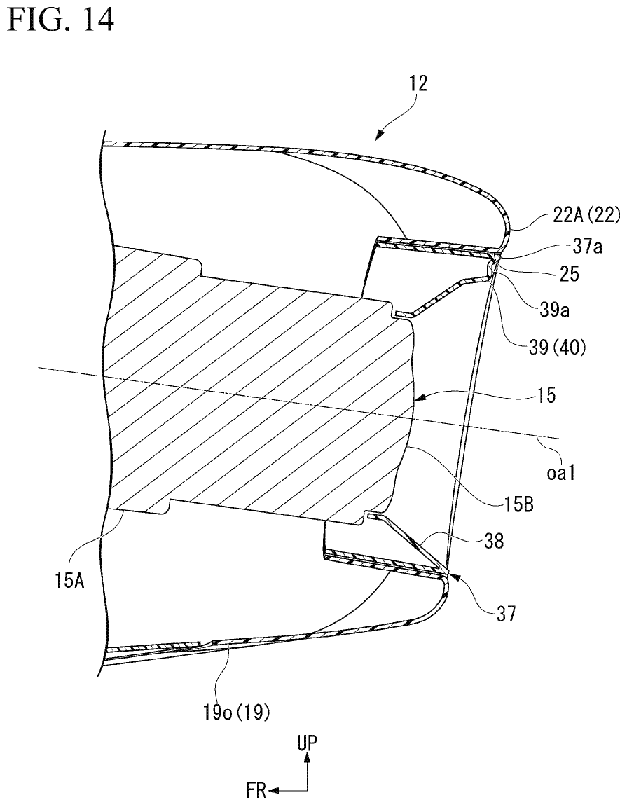

FIG. 14 is a view showing a cross-section along a XIV-XIV line of FIG. 11.

As shown in FIGS. 12 to 14, a lens hood 37 that covers a circumferential area of the imaging lens 15B of the rearward direction imaging device 15 is attached to the first lens exposure hole 25 at a rear end of the housing 19 (outer housing 19o). The lens hood 37 has a truncated conical hood wall 38 that extends obliquely outward in a radial direction thereof from the circumferential area of the imaging lens 15B toward the imaging direction. An inclination angle of the hood wall 38 relative to the optical axis oa1 of the imaging lens 15B is differently set between an outer area having the groove 32 (notched part) of the housing 19 and an inner area on a side opposite to the outer area with the optical axis oa1 interposed therebetween.

Specifically, as shown in FIG. 13, an inclination angle α1 of the outer area is set to be equal to or more than a field angle of the imaging lens 15B and to be smaller than an inclination angle α2 of the inner area. In the circumferential direction of the hood wall 38, an angular difference between the inclination angle α1 of the inner area and the inclination angle α2 of the outer area is the largest, and the inclination angle changes continuously between the inner area and the outer area. The inclination angle of the hood wall 38 with respect to the optical axis oa1 is set such that widths of the outer area and the inner area in the radial direction of the hood wall 38 appear to be the same when the housing 19 is viewed from the rearward direction.

As shown in FIGS. 12 and 14, a stepped part 39 having a substantially vertical surface 39a that is directed in the imaging direction is formed in an upper region of the imaging lens 15B in the hood wall 38 of the lens hood 37 when seen from a direction of the optical axis oa1 of the imaging lens 15B. The stepped part 39 is formed of a protrusion 40 that protrudes in the imaging direction with respect to an inclined surface of the hood wall 38. The protrusion 40 is formed in an arc shape substantially along an outer circumferential edge part of the hood wall 38 when seen from a direction of the optical axis oa1.

The protrusion 40 can also be formed in an annular shape when seen from the direction of the optical axis oa1.

The protrusion 40 (stepped part 39) is formed to be recessed frontward from an outer circumferential end part 37a (an end part in an imaging target direction) of the lens hood 37.

The imaging unit 12 of the present embodiment is arranged at a height equal to or less than that of the side part of the vehicle 1.

Hereinafter, this will be described with reference to FIG. 2. In FIG. 2, a door waist part 36 and a character line 35 at the side part of the vehicle body are shown. The character line 35 is a convex ridge line part that is provided to protrude on the outer surface of the side portion of the vehicle body including the front side door 5 and extends substantially in the vehicle front-to-rear direction. A door waist part 36 is an upper side part of a door main body of the front side door 5 and seemingly constitutes a lower side of a window frame part in which the door glass 6 moves upward and downward.

The imaging unit 12 is arranged in a height range from a height of 925 mm from a ground surface to a maximum vehicle height h2.

In the case of the present embodiment, the imaging unit 12 is arranged at a higher position than a height h1 of the character line 35 of the front side door 5 and a lower position than the door waist part 36 of the front side door 5.

In the case of the present embodiment, a retractable flash door handle 45 is provided on a rear edge part of the outer surface of the front side door 5. The flash door handle 45 is formed in a horizontally elongated rectangular shape in a side view of the vehicle. The imaging unit 12 that is attached to a front edge part of the outer surface of the front side door 5 is formed in a horizontally elongated rectangular shape having the same size and substantially the same shape as those of the flash door handle 45 in a side view of the vehicle. The imaging unit 12 and the flash door handle 45 are arranged at point-symmetrical positions with respect to a centering point on the character line 35 in a side view of the vehicle.

As described above, in the arrangement structure of the imaging unit 12 of the present embodiment, since an arrangement height of the imaging unit 12 is in a height range from a height of 925 mm from the ground surface to the maximum vehicle height h2, halation due to the light of headlight of the following vehicle is less likely to occur. That is, in the present embodiment, since the imaging unit 12 is arranged at a height of 950 mm as a maximum arrangement height of a headlight of a general vehicle used on a public road, that is, at a height equal to or more than 925 mm in consideration of a downward inclination of the optical axis of the headlight, it is possible to prevent occurrence of halation in the image of the monitor 11 when the light of headlight of the following vehicle directly enters the rear imaging device 15. Accordingly, when the arrangement structure of the imaging unit 12 of the present embodiment is employed, it is possible to clearly recognize the silhouette of the following vehicle using the monitor 11 when traveling at night.

Further, in the arrangement structure of the imaging unit 12 of the present embodiment, the imaging unit 12 is arranged at a lower position than the door waist part 36 of the front side door 5. Therefore, it becomes difficult for the imaging unit 12 to enter the driver's view through the window frame part of the front side door 5. Accordingly, when the arrangement structure of the imaging unit 12 of the present embodiment is employed, it is possible to further widely ensure the driver's direct view.

Further, in the arrangement structure of the imaging unit 12 of the present embodiment, the vehicle imaging unit 12 is arranged at a higher position than the height h1 of the character line 35 on the side part of the vehicle body. Therefore, as shown in FIG. 2, a splash s that is splashed by a front wheel Wf of the vehicle when the vehicle is traveling is blocked by the raised part of the character line 35 and hardly adheres to the vehicle imaging unit 12. Accordingly, in a case where the arrangement structure of the imaging unit 12 of the present embodiment is employed, even when the vehicle travels under a bad weather condition, it is possible to make the image that is captured by the rearward direction imaging device 15 and the downward direction imaging device 17 of the imaging unit 12 further clear.

Further, in the arrangement structure of the imaging unit 12 of the present embodiment, the retractable flash door handle 45 is provided on the outer surface of the front side door 5, and the vehicle imaging unit 12 and the flash door handle 45 are formed in the substantially same size and arranged at point-symmetrical positions with respect to a centering point on the character line 35 in a vehicle side view. Therefore, when the front side door 5 is seen from a side direction of the vehicle, the imaging unit 12 and the flash door handle 45 are arranged in a balanced manner so as to interpose the character line 35. Accordingly, when the arrangement structure of the present embodiment is employed, it is possible to enhance the appearance design property of the front side door 5.

Further, in the arrangement structure of the imaging unit 12 of the present embodiment, the imaging unit 12 is arranged at a height position at which an amount of reflection of the vehicle with respect to the entire display screen 13 of the monitor 11 is equal to or less than a predetermined value (for example, 10% or less). Therefore, when the arrangement structure of the present embodiment is employed, it is possible to sufficiently ensure an amount of reflection of surroundings of the vehicle in the display screen 13 of the monitor 11.

The present invention is not limited to the embodiment described above, and a variety of design changes can be made without departing from the scope of the present invention.

What is claimed is:

1. A vehicle imaging unit arrangement structure which is an arrangement structure of a vehicle imaging unit that is arranged on an outside part of a vehicle and that includes an imaging device which captures an image of a surrounding of the vehicle and which outputs the captured image to a display device,
wherein the vehicle imaging unit is arranged in a height range from a height of 925 mm from a ground surface to a maximum vehicle height.

2. The vehicle imaging unit arrangement structure according to claim 1,
wherein the vehicle imaging unit is arranged at a lower position than a door waist part of a side door.

3. The vehicle imaging unit arrangement structure according to claim 1,
wherein the vehicle imaging unit is arranged at a higher position than a character line that is provided to protrude on an outer surface of a vehicle body side part and that extends substantially in a vehicle front-to-rear direction.

4. The vehicle imaging unit arrangement structure according to claim 3,
wherein the vehicle imaging unit is arranged at a side door that includes a retractable flash door handle on an outer surface of the side door, and
the vehicle imaging unit and the flash door handle are formed in the substantially same size and arranged at point-symmetrical positions with respect to a centering point on the character line in a vehicle side view.

5. The vehicle imaging unit arrangement structure according to claim 1,
wherein the vehicle imaging unit is arranged at a height position at which a ratio of an amount of reflection of the vehicle to an entire display screen of the display device is equal to or less than a predetermined value.

6. The vehicle imaging unit arrangement structure according to claim 2,
wherein the vehicle imaging unit is arranged at a higher position than a character line that is provided to protrude on an outer surface of a vehicle body side part and that extends substantially in a vehicle front-to-rear direction.

7. The vehicle imaging unit arrangement structure according to claim 6,
wherein the vehicle imaging unit is arranged at a side door that includes a retractable flash door handle on an outer surface of the side door, and
the vehicle imaging unit and the flash door handle are formed in the substantially same size and arranged at point-symmetrical positions with respect to a centering point on the character line in a vehicle side view.

8. The vehicle imaging unit arrangement structure according to claim 2,
wherein the vehicle imaging unit is arranged at a height position at which a ratio of an amount of reflection of the vehicle to an entire display screen of the display device is equal to or less than a predetermined value.

9. The vehicle imaging unit arrangement structure according to claim 3,
wherein the vehicle imaging unit is arranged at a height position at which a ratio of an amount of reflection of the vehicle to an entire display screen of the display device is equal to or less than a predetermined value.

10. The vehicle imaging unit arrangement structure according to claim 4,
wherein the vehicle imaging unit is arranged at a height position at which a ratio of an amount of reflection of the vehicle to an entire display screen of the display device is equal to or less than a predetermined value.

11. The vehicle imaging unit arrangement structure according to claim 6,
wherein the vehicle imaging unit is arranged at a height position at which a ratio of an amount of reflection of the vehicle to an entire display screen of the display device is equal to or less than a predetermined value.

12. The vehicle imaging unit arrangement structure according to claim 7,
wherein the vehicle imaging unit is arranged at a height position at which a ratio of an amount of reflection of the vehicle to an entire display screen of the display device is equal to or less than a predetermined value.
